(19) United States
(12) Patent Application Publication
(10) Pub. No.: US 2012/0037818 A1
(43) Pub. Date: Feb. 16, 2012

(54) SYSTEMS, METHODS AND COMPUTER-ACCESSIBLE MEDIA FOR OBTAINING THREE-DIMENSIONAL INFORMATION FROM TWO-DIMENSIONAL FLUORESCENCE EMISSION DATA

(75) Inventor: Alexander Klose, New York, NY (US)

(73) Assignee: The Trustees of Columbia University in the City of New York, New York, NY (US)

(21) Appl. No.: 13/147,750

(22) PCT Filed: Apr. 30, 2010
(86) PCT No.: PCT/US10/33267

§ 371 Date: Nov. 2, 2011

Related U.S. Application Data
(60) Provisional application No. 61/174,757, filed on May 1, 2009.

(51) Int. Cl. G01N 21/64

(52) U.S. Cl. 250/459.1; 250/458.1; 250/208.1

(57) ABSTRACT

Exemplary embodiments of a computer-accessible medium, method and system for providing information are provided. A first detection arrangement can be provided which can be configured to detect electro-magnetic radiations from a fluorescent particle(s) in a portion of a structure, and generate information associated with the portion of the structure. A second arrangement can be configured to generate a two-dimensional image and/or a three-dimensional image of the at least one portion of the structure as a function of the information. The electro-magnetic radiations can have different wavelengths.

### CROSS-REFERENCE TO RELATED APPLICATION(S)

This application relates to and claims priority from U.S. patent application Ser. No. 61/174,757 filed May 1, 2009, the entire disclosure of which is hereby incorporated herein by reference.

### FIELD OF THE DISCLOSURE

The present disclosure relates to exemplary embodiments of computer-accessible medium, methods and systems for obtaining three-dimensional (3D) information, and more particularly, to exemplary embodiments of computer-accessible medium, methods and systems for obtaining three-dimensional information from two-dimensional (2D) fluorescence emission data.

### BACKGROUND INFORMATION

Fluorescence and luminescence imaging of living animals can be a useful technique for obtaining information on both normal and diseased biological processes taking place in that animal. The images can generally be obtained with low light level CCD cameras or other sensitive optical imaging devices, and the biological process can be visualized using luminescent or fluorescent probes which are produced by or which target some compound (e.g. enzyme, protein, etc.), or some cell surface receptor which is part of the process. The images generally can show regions of optical emission which can be correlated with the biological process.

In the use of fluorescent probes, the targeting molecules generally do not emit light until illuminated with an appropriate wavelength light source of defined bandwidth that stimulates fluorescence emission. The emitted light then likely propagates from its source of emission to the imaging detector which can view the tissue surface of the animal through a narrow band filter that passes the emission wavelength but blocks the illumination wavelength. Because the animal itself has a relatively high opacity, both the illumination and emission light can be scattered many times before it reaches the detector. Thus, the multiple scattering of biological tissue can make it difficult to see directly an emission source that is deep inside the animal, and further makes it difficult to compute the intrinsic strength of this emission source.

Computational reconstruction techniques based on numerical modeling of light propagation in animal tissue can improve the imaging process leading to quantitative results about the spatial source position and emission strength. However, in conventional techniques where the illumination is provided only from one direction and the imaging takes place in a single plane (“single view”), it may still be difficult or even impossible to obtain accurate estimates of source size, position, and emission strength inside the animal. In other words, it may be difficult or even impossible to distinguish if a source is a weak emitter and/or near the surface, or a strong emitter and deep inside the animal.

Thus, there is a need overcome at least some of the deficiencies and/or issues with the conventional techniques for fluorescence and luminescence imaging of living animals described herein above.

### SUMMARY OF EXEMPLARY EMBODIMENTS OF THE DISCLOSURE

At least some of the above described problems can be addressed by exemplary embodiments of the computer-accessible medium, methods and systems according to the present disclosure.

One of the exemplary objects of exemplary embodiments of the present disclosure is to improve the accuracy with which the 3D extent, location and intrinsic strength of fluorescent sources can be estimated inside a living animal. This can be achieved by, e.g., providing additional information to the physical model so that the reconstruction technique can reduce or remove the ambiguity relating source strength and depth. The additional information, which can be facilitated by a multi-wavelength emission under single wavelength excitation, can provide additional data to the physical model in order to improve the 3D source reconstruction.

Thus, according to certain exemplary embodiments of the present disclosure, computer-accessible medium, method and system can be provided with which information can be provided. For example, an apparatus can be provided for providing information, comprising a first detection arrangement configured to (i) detect at least two electro-magnetic radiations from at least one fluorescent particle in a portion of a structure, and (ii) generate information associated with the at least one portion of the structure, and a second arrangement configured to generate at least one of a two-dimensional image or a three-dimensional image of the at least one portion of the structure as a function of the information. The structure can be an anatomical structure.

The apparatus can further comprise at least one source arrangement which can be configured to generate the electro-magnetic radiations, each of the electro-magnetic radiations having a first wavelength which is different from a second wavelength of another one of the electro-magnetic radiations, wherein the at least one source arrangement is further configured to tune the wavelengths of the electro-magnetic radiations to stimulate the at least one fluorescent particle.

The at least one source arrangement can generate the at least two electro-magnetic radiations at a wavelength that is smaller than a wavelength of an emission of radiation by the at least one fluorescent particle. The at least one fluorescent particle can include a plurality of fluorescent particles, wherein the at least one source arrangement can be configured to target a particular fluorescent particle of the fluorescent particles in the structure based on at least one known characteristic of each of the fluorescent particles. The at least one source arrangement can be configured to target a particular location in the at least one portion of the structure without a knowledge of characteristics of the at least one fluorescent particle.

The at least one fluorescent particle can include at least one fluor, which can be an AlexaFluor. The at least one fluorescent particle can include a plurality of fluorescent particles, wherein the fluorescent particles can generate the electro-magnetic radiations based on different respective characteristics thereof. The characteristics can include a size of respective ones of the fluorescent particles. The at least one of the two-dimensional image or the three-dimensional image can include different image contrasts associated with the at least one portion of the structure.

Further, a method for providing information can be provided, comprising stimulating at least two fluorescent particles in at least one portion of a structure to generate electro-magnetic radiations at different wavelengths of one another based on different characteristics of the at least two fluorescent particles, and obtaining the electro-magnetic radiations to generate at least one of a two-dimensional image or a three-dimensional image of the at least one portion of the structure.

Also, a computer-accessible medium having instructions thereon for information can be provided, wherein, when a hardware processing arrangement executes the instructions, the computing arrangement is configured to cause a stimulation of at least two fluorescent particles in at least one portion of a structure to generate electro-magnetic radiations at different wavelengths of one another based on different characteristics of the at least two fluorescent particles, and obtain signals associated with the electro-magnetic radiations to generate at least one of a two-dimensional image or a three-dimensional image of the at least one portion of the structure.

These and other objects, features and advantages of the exemplary embodiment of the present disclosure will become apparent upon reading the following detailed description of the exemplary embodiments of the present disclosure, when taken in conjunction with the appended claims.

### BRIEF DESCRIPTION OF THE DRAWINGS

The foregoing and other objects of the present disclosure will be apparent upon consideration of the following detailed description, taken in conjunction with the accompanying drawings and claims, in which like reference characters refer to like parts throughout, and in which:

FIG. 1 is a graph showing exemplary absorption spectra of chromophores found in tissue according to an exemplary embodiment of the present disclosure;

FIG. 2 is an illustration of a graph showing an exemplary emission spectrum of cadmium selenide (CdSe) nanoparticles according to an exemplary embodiment of the present disclosure;

FIG. 3 is an illustration of a graph showing an exemplary emission spectra of different AlexaFluor dyes according to an exemplary embodiment of the present disclosure;

FIG. 4 is a block diagram of an exemplary embodiment of a system according to the present disclosure; and

FIG. 5 is a flow diagram according to an exemplary embodiment of a method of the present disclosure.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative embodiments. It is intended that changes and modifications can be made to the described embodiments without departing from the true scope and spirit of the subject disclosure.

### DETAILED DESCRIPTION OF EXEMPLARY EMBODIMENTS OF DISCLOSURE

Exemplary embodiments of the computer-accessible medium, methods and systems according to the present disclosure are described below.

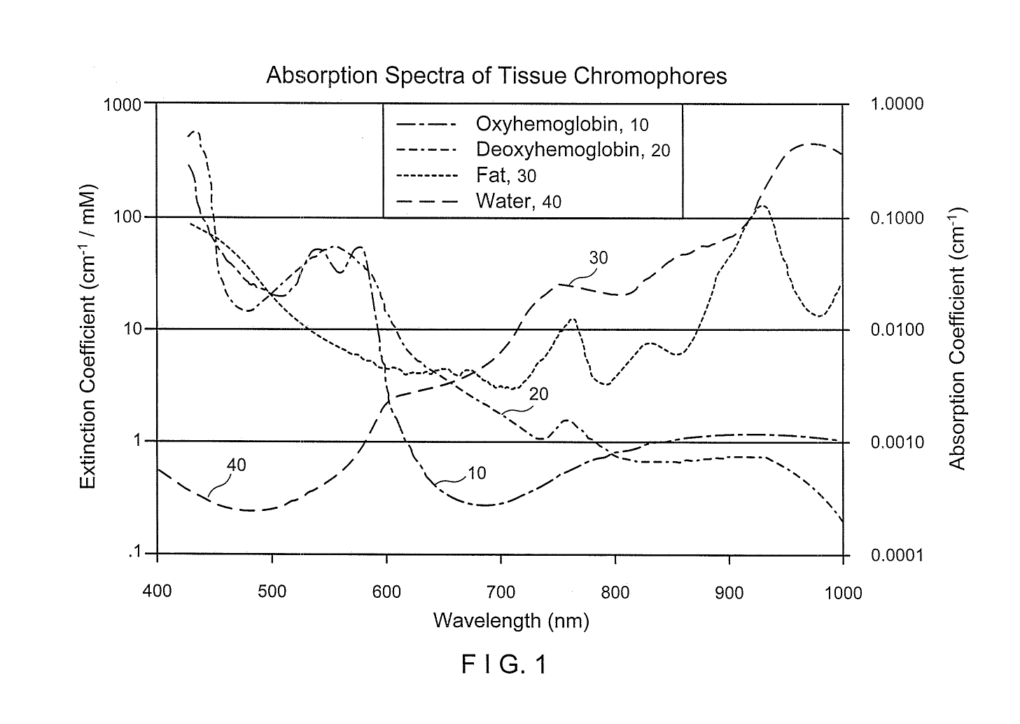

The exemplary embodiments of the present disclosure can utilize the concept that the scattering and absorption properties of animal tissue at the emission wavelength can be strongly wavelength dependent, as shown in FIG. 1. Thus, if exemplary measurements can be made at several different fluorescence emission wavelengths, there can be a physical way to distinguish between a weak source near the surface and a strong one deep inside an animal. This can be accomplished, e.g., by using the spectral information of fluorescence light.

A two emission wavelength example according to an exemplary embodiment of the present disclosure can be as follows.

For example, if at one wavelength there is a strong absorption and at the other wavelength there is only a weak absorption, then a dual-emission wavelength fluorescent source close to the surface which is excited by a single wavelength can appear at about equal strength at both of the wavelengths. However, e.g., a deep source can be seen most strongly at the wavelength with weak absorption, and can be seen most weakly in the image at the wavelength that is strongly absorbed. Furthermore, the source at the wavelength with the strongest absorption can be better resolved because more of the scattered light can be likely absorbed.

This exemplary model can be utilized to initially effectuate an imaging and reconstruction strategy for obtaining the useful combinations of images at different wavelengths that can be chosen to provide information on the depth of the fluorescing source. To be useful, the selected combination of fluors can have the following exemplary characteristics.

First, e.g., the emission wavelengths can span a spectrum region where the tissue opacity as a function of scattering and absorption properties is changing sufficiently. The exemplary spectral dependence of opacity is shown in the graph of FIG. 1. This exemplary graph of FIG. 1 illustrates an exemplary absorption spectra of chromophores found in a tissue, and provides the spectral dependence of the light absorption coefficient of tissue for different tissue components such oxy-hemoglobin (HbO₂) 10, as hemoglobin (Hb) 20, and water (H2O) 30. Hemoglobin spectra 20 can be provided in terms of an extinction coefficient on a left side of the graph, and fat 30 and water 40 spectra can be provided in terms of absorption coefficient on a right side of the graph of FIG. 1. As seen in FIG. 1, a steep rise in the absorption can be found at wavelengths smaller than about 760 nm for hemoglobin 20. Useful wavelength regions can be in the exemplary range of, e.g., about 560-800 nm.

Second, e.g., the chemistry of the different fluors can be similar so that a single targeting molecule attached to all of them can have essentially the same in vivo properties independent of which wavelength fluor it is attached to.

There can be a variety of ways to generate families of fluorescent compounds with similar chemical structures but different emission wavelengths. One of the exemplary ways to generate such families can be to create nanoparticles with a broad size distribution. Since the emission wavelength of a particular type (composition) of nanoparticle can depend on its size, this exemplary procedure can provide a range of emission wavelengths with some or all of the particles having similar chemical properties determined by the coating (e.g., cladding) that is used. Nanoparticles can also have a useful property that their fluorescence can be excited by a broad range of wavelengths, regardless of the emission wavelength.

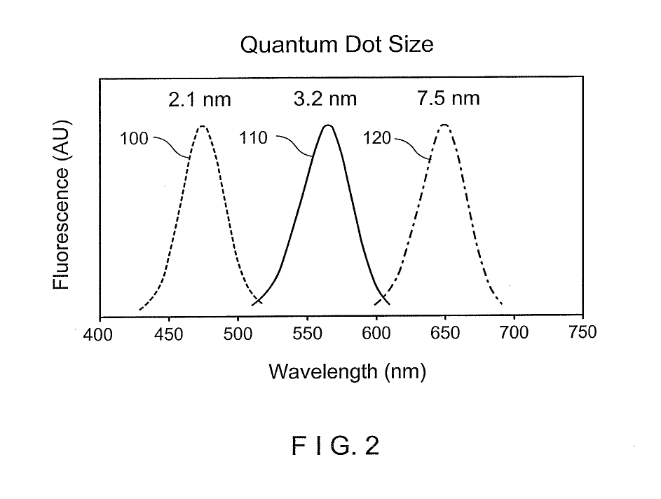

For example, the results of such exemplary procedure can be shown for typical (or exemplary) nanoparticle fluors as illustrated in FIG. 2, which illustrates an exemplary emission spectrum of cadmium selenide (CdSe) nanoparticles. Such exemplary emission spectrum can be changed by, e.g., changing the size of the nanoparticles. FIG. 2 shows a graph illustrating an exemplary emission spectrum of cadmium selenide (CdSe) nanoparticles according to an exemplary embodiment of the present disclosure. As shown in FIG. 2 (viewed from the left side of the graph to the right side) the exemplary spectra for the nanoparticles having a diameter of 2.1 nm (curve 100), 3.2 nm (curve 110) and 7.5 nm (curve 120) are indicated. Quantum dots and nanoparticles of various diameters can emit light at different wavelengths when stimulated by light sources. Quantum dots or nanoparticles can therefore be used for exemplary tomographic imaging.

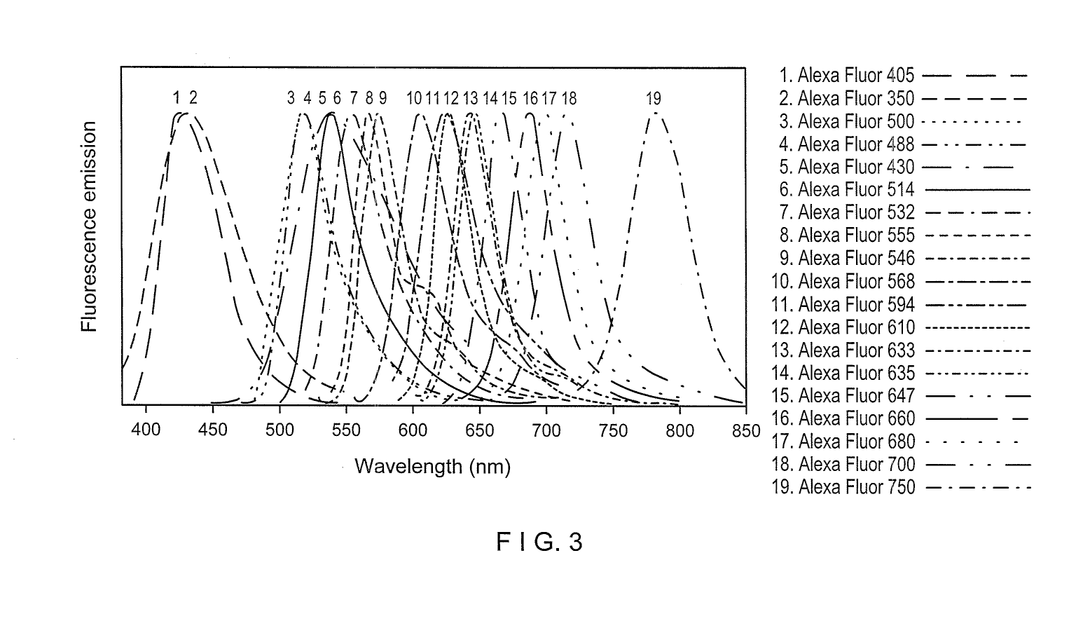

Another exemplary way to generate a broad spectrum of emission wavelengths can be, e.g., to utilize a chemically related series of fluors which can be designed or configured to have different emission wavelengths. This can be performed, e.g., using commercially available fluors, such as the AlexaFluor family. Exemplary characteristic(s) of such implementation can be that the emission wavelengths span the useful range of the spectrum indicated above and that the linkage chemistry of the fluors to the targeting molecule be similar. At least some of these fluors can have a relatively narrow range of excitation wavelengths so that multiple wavelength sources can be used to excite multiple wavelengths. Exemplary emission wavelengths, e.g., of a family of AlexaFluor dyes are shown in FIG. 3 (which provides a graph showing an exemplary emission spectra of different AlexaFluor dyes according to an exemplary embodiment of the present disclosure) for, e.g., nineteen different AlexaFluor dyes, with the right part of the graph providing a key for the particular AlexaFluor dye.

Certain exemplary embodiments of the present invention facilitate a generation of a family of fluorescence labeled targeting molecules with emission wavelengths spanning the useful range, and such family possibly having similar attachment chemistry and similar in vivo targeting properties. For example, exemplary images can then be acquired at several different (at least two) wavelengths, where the absorption spectrum of Hb and HbO₂ change sufficiently. These exemplary images can be used, according to certain exemplary embodiments of the present disclosure, with the existing numerical reconstruction procedure or software to model the wavelength dependent light propagation physics of the scattering processes inside tissue at the emission wavelength. For example, the determined or computed light intensities on the tissue surface as a function of the wavelength can be compared to the measured light intensities. Iterative or direct inversion techniques can subsequently be used to recover the unknown fluorescent source distribution inside the tissue. The exemplary techniques described herein can be performed using a processor/computer or a group of processors/computers. In addition, the exemplary procedures described herein can be implemented using a computer software which can be stored on a computer-accessible medium (e.g., at least one hard drive, floppy disk, memory stick or card, RAM, ROM, or any other computer storage device), and such software can be accessed and/or loaded by the processor(s)/computer(s) to configure such processor(s)/computer(s) to execute the instructions of the software thereon.

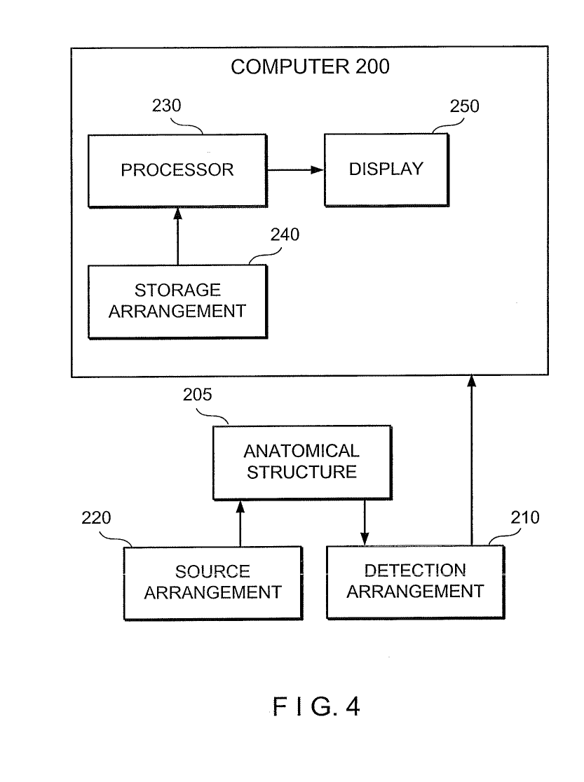

FIG. 4 illustrates a block diagram of an exemplary embodiment of a system according to the present disclosure which can be used to perform and/or implement the exemplary procedures described herein. For example, the exemplary system can have a source arrangement 220 that is configured to generate electromagnetic radiation on at least one fluorescent particle on at least a portion of the anatomical structure 205 to stimulate the fluorescent particle. Such one or more portions of the anatomical structure 205 can have therein (or provided thereto) a plurality of fluorescent particles. The source arrangement 220 can generate at least two electro-magnetic radiations, where each of the electro-magnetic radiations can have different wavelengths. The source arrangement can further be configured (e.g., manually and/or automatically by computer(s) 200) to tune the wavelengths of the electro-magnetic radiations so as to stimulate the fluorescent particle in the anatomical structure 205.

A detection arrangement 210 of the exemplary system shown in FIG. 4 can be configured (e.g., automatically by the computer(s) 200) to detect the electro-magnetic radiation from at least one of the fluorescent particles in the portion of the anatomical structure 205. For example, the source arrangement 220 and the detection arrangement 210 can be provided as a single apparatus or separate devices. The detection arrangement 210 can then generate information associated with such one or more portions of the structure, and also provide such information to a computer 200. The processor(s)/computer(s) 200 can be a part of the detection arrangement 210, or separate from the detection arrangement 210.

The computer(s) 200 can be configured to generate a two-dimensional image and/or a three-dimensional image of the at least one portion of the structure as a function of the information. The information and/or the images can be stored on the computer(s) 200, which can include a personal computer, a mini computer, mainframe, etc., or a combination thereof, that can be connected to the detection arrangement 210 by, e.g., a standard USB port or wirelessly. The information can be provided by the detection arrangement 210 to the computer(s) 200 as data, which can be transmitted to a processor 230 and/or a storage arrangement 240. The processor 230 can be configured and/or programmed to perform the exemplary steps and/or procedures of the exemplary embodiments of the techniques described above. For example, the processor 230 can generate the two-dimensional image and/or the three-dimensional image based on the information provided by the detection arrangement 210.

According to one exemplary embodiment of the present disclosure, the information from the detection arrangement 210 can be processed by the processor 230 and/or can be stored in a storage arrangement 240 (e.g., hard drive, memory device, such as RAM, ROM, memory stick, floppy drive, etc.)—a computer-accessible medium which is tangible. The processor 230 can access the storage arrangement 140 to execute a computer program or a set of instructions (stored on or in the storage arrangement 240) which perform the procedures according to the exemplary embodiments of the present disclosure.

Thus, e.g., when the processor 230 performs such instructions and/or computer program, the processor 230 can be configured or programmed to perform the exemplary embodiments of the procedures according to the present disclosure, as described above herein. For example, the processor 230 can receive the information from the detection arrangement 210 and/or the storage arrangement 240, and then generate the two-dimensional image and/or the three-dimensional image based on the information received.

A display 250 can also be provided for the exemplary system of FIG. 10. The storage arrangement 240 and the display 250 can be provided within the computer 200 or external from the computer 200, and the computer can be provided as part of the detection arrangement 210 or separate from the detection arrangement 210. The information received by the processor 230 and the images generated by the processor 230, as well as the information stored on the storage arrangement 240 can be displayed on the display 250 in a user-readable format. For example, the display 250 can display the two-dimensional image and/or the three-dimensional image based on the information received by the detection arrangement 210.

For example, the source arrangement 220 can generate at least two electro-magnetic radiations at a wavelength that is smaller than a wavelength of an emission of radiation by at least one of the fluorescent particles in the structure 205. The source arrangement can be configured to target a particular fluorescent particle in a plurality of fluorescent particles in the structure 205 based on at least one known characteristic of each of the plurality of fluorescent particles. The source arrangement can also be configured to target a particular location in the at least one portion of the structure without a knowledge of characteristics of the at least one fluorescent particle.

The fluorescent particle can comprise a fluor, such as an AlexaFluor. The fluorescent particles in the portion of the structure 205 can generate electro-magnetic radiations based on different respective characteristics thereof, such as the size of the fluorescent particles. The two-dimensional image or the three-dimensional image generated can include different image contrasts associated with the portion of the structure 205.

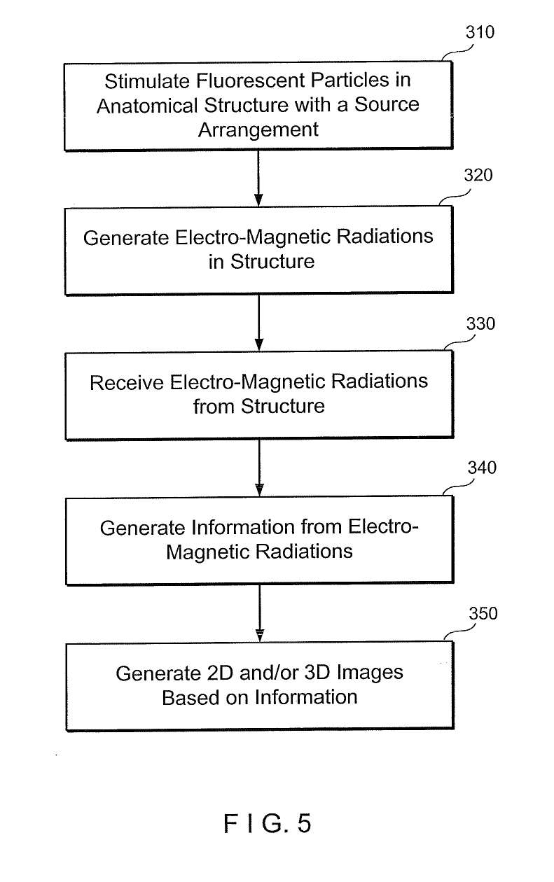

FIG. 5 illustrates a flow diagram according to an exemplary method for providing three-dimensional information. Initially, e.g., at 310, one or more fluorescent particles can be stimulated in a portion of an anatomical structure to generate electro-magnetic radiations at different wavelengths of one another using, e.g., a source arrangement. The stimulation can be based on different characteristics of the fluorescent particles. This stimulation can be effectuated by the source arrangement forward the electromagnetic radiation to the anatomical structure. The exemplary stimulation can involve targeting a particular one of the fluorescent particles based on at least one known characteristic of the fluorescent particle, and/or can of a particular location in at least one portion of the anatomical structure without knowledge of the characteristics of the fluorescent particles.

The electro-magnetic radiations can be generated at a wavelength that is smaller than a wavelength of an emission of the electromagnetic radiation by at least one of the fluorescent particles at 320. The electromagnetic radiations are received and/or obtained from the structure at 330. Information can then be generated that is associated with the electro-magnetic radiations at 340, and then at least one of a two-dimensional image or a three-dimensional image is generated at 350 of the at least one portion of the structure.

Various other considerations can also be addressed in the exemplary applications described according to the exemplary embodiments of the present disclosure. Various information can be generated based on the electro-magnetic radiations received. Different anatomical structures can be provided having fluorescent particles. The exemplary embodiments of the present disclosure can be used in various configurations and in different systems. Various computing arrangements can be provided, having a processor(s) configured or programmed to perform the exemplary steps and/or procedures of the exemplary embodiments of the present disclosure described above. Various data described above can be stored in various storage arrangements (e.g., hard drive, memory device, such as RAM, ROM, memory stick, floppy drive, other tangible computer-accessible medium, etc.). The computer(s)/processor(s) can access the storage arrangement(s) to execute a computer program or a set of instructions (stored on or in the storage arrangement) which can perform the procedures according to the exemplary embodiments of the methods and systems of the present disclosure.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, manufacture and methods which, although not explicitly shown or described herein, embody the principles of the disclosure and are thus within the spirit and scope of the disclosure. In addition, to the extent that the prior art knowledge has not been explicitly incorporated by reference herein above, it is explicitly being incorporated herein in its entirety. All publications referenced herein above are incorporated herein by reference in their entireties, as applicable. In the event of a conflict between the teachings of the present disclosure and those of the incorporated document, the teachings of the present disclosure control.

What is claimed is:

1. An apparatus for providing information, comprising:
a first detection arrangement configured to (i) detect at least two electro-magnetic radiations from at least one fluorescent particle in a portion of a structure, and (ii) generate information associated with the at least one portion of the structure; and
a second arrangement configured to generate at least one of a two-dimensional image or a three-dimensional image of the at least one portion of the structure as a function of the information.

2. The apparatus according to claim 1, wherein the structure is an anatomical structure.

3. The apparatus according to claim 1, further comprising at least one source arrangement which is configured to generate the electro-magnetic radiations, each of the electro-magnetic radiations having a first wavelength which is different from a second wavelength of another one of the electro-magnetic radiations, wherein the at least one source arrangement is further configured to tune the wavelengths of the electro-magnetic radiations to stimulate the at least one fluorescent particle.

4. The apparatus according to claim 3, wherein the at least one source arrangement generates the at least two electro-magnetic radiations at a wavelength that is smaller than a wavelength of an emission of radiation by the at least one fluorescent particle.

5. The apparatus according to claim 3, wherein the at least one fluorescent particle includes a plurality of fluorescent particles, and wherein the at least one source arrangement is configured to target a particular fluorescent particle of the fluorescent particles in the structure based on at least one known characteristic of each of the fluorescent particles.

6. The apparatus according to claim 3, wherein the at least one source arrangement is configured to target a particular location in the at least one portion of the structure without a knowledge of characteristics of the at least one fluorescent particle.

7. The apparatus according to claim 1, wherein the at least one fluorescent particle includes at least one fluor.

8. The apparatus according to claim 1, wherein the at least one fluorescent particle includes at least one AlexaFluor.

9. The apparatus according to claim 1, wherein the at least one fluorescent particle includes a plurality of fluorescent particles, and wherein the fluorescent particles generate the electro-magnetic radiations based on different respective characteristics thereof.

10. The apparatus according to claim 9, wherein the characteristics include a size of respective ones of the fluorescent particles.

11. The apparatus according to claim 1, wherein the at least one of the two-dimensional image or the three-dimensional image includes different image contrasts associated with the at least one portion of the structure.

12. A method for providing information, comprising:
stimulating at least two fluorescent particles in at least one portion of a structure to generate electro-magnetic radiations at different wavelengths of one another based on different characteristics of the at least two fluorescent particles; and
obtaining the electro-magnetic radiations to generate at least one of a two-dimensional image or a three-dimensional image of the at least one portion of the structure.

13. The method according to claim 12, wherein the structure is an anatomical structure.

14. The method according to claim 12, further comprising generating the electro-magnetic radiations at a wavelength that is smaller than a wavelength of an emission of radiation by at least one of the fluorescent particles.

15. The method according to claim 12, wherein the stimulating procedure comprises targeting a particular one of the at least two fluorescent particles based on at least one known characteristic of the particular one of the at least two fluorescent particles.

16. The method according to claim 12, wherein the stimulating procedure comprises targeting a particular location in the at least one portion of the structure without a knowledge of the characteristics of at least one of the at least two fluorescent particles.

17. The method according to claim 12, wherein the at least one fluorescent particle includes at least one fluor.

18. The method according to claim 12, wherein the at least one fluorescent particle includes at least one AlexaFluor.

19. The method according to claim 12, wherein the at least two fluorescent particles generate the electro-magnetic radiations based on different respective characteristics thereof.

20. The method according to claim 19, wherein the characteristics include a size of respective ones of the fluorescent particles.

21. A computer-accessible medium having instructions thereon for information, wherein, when a hardware processing arrangement executes the instructions, the computing arrangement is configured to:
cause a stimulation of at least two fluorescent particles in at least one portion of a structure to generate electro-magnetic radiations at different wavelengths of one another based on different characteristics of the at least two fluorescent particles; and
obtain signals associated with the electro-magnetic radiations to generate at least one of a two-dimensional image or a three-dimensional image of the at least one portion of the structure.
